(19) United States
(12) Patent Application Publication
(10) Pub. No.: US 2006/0121237 A1
(43) Pub. Date: Jun. 8, 2006

(54) Reduced stain wick back

(76) Inventors: Peter Michael Murphy, Chadds Ford, PA (US); Stephen Ernest Jacobson, Hockessin, DE (US); Melea Rena Langley, Ringgold, GA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/004,693

(22) Filed: Dec. 3, 2004

(51) Int. Cl. D03D 27/00; B32B 33/00

(52) U.S. Cl. 428/95; 428/97

(57) ABSTRACT

A carpet backing comprising a styrene butadiene rubber latex and at least one adsorbent, said backing reducing the reappearance, or wick back, of stains on carpet after cleaning of the carpet is disclosed.

### FIELD OF THE INVENTION

This invention relates to compositions and methods for the reduction of the reappearance, or “wick back”, of stains on styrene-butadiene rubber latex-backed carpets after being cleaned and allowed to dry.

### BACKGROUND OF THE INVENTION

Styrene-butadiene rubber (SBR) latex is commonly used as a backing material for carpets. Certain stains, particularly those from coffee, can seep into the latex backing. Stains absorbed in the latex are generally not completely removed during cleaning, and then migrate back into the carpet fiber and become visible at the carpet fiber surface as the carpet dries. The area where this occurs can be larger than the stained area.

Nearly all carpet manufacturers and carpet fiber producers recommend “Hot Water Extraction” or “Steam Cleaning” as the cleaning method for carpet. In the trade, this is the only cleaning method classified as “deep cleaning”. Other cleaning methods, including shampoo cleaning, dry powder methods, bonnet cleaning, and other methods, are considered “light surface-cleaning” because they are do not remove soil and stain deep in the pile. These light surface-cleaning methods also leave cleaning agents in the carpet after cleaning. Conventional indoor carpeting having SBR backing may allow the stain to seep through the fibers and spread into the backing. In such cases, it is not unusual for stains to reappear after spot cleaning with water and ordinary cleaners. This is referred to as “wicking” or “wicking back”. Subsequent cleaning is needed to remove the stain from the carpet fibers. Liquids, particularly from large spills, seep into the backing and remain there after cleaning. Through capillary action, the stain can “wick back” up into the carpet fibers.

The use of additives in SBR latex carpet backing to reduce the odors from the SBR backing itself is known. Kurzmann, et al, in German Patent DE 3023023, disclose SBR latexes for carpet backing containing active carbon to produce an “essentially odorless” polypropylene carpet. Kurzmann et al. did not disclose the use of the additives to the SBR latex backing to minimize wicking back of stains and odors after carpet cleaning.

It is desirable to improve the properties of carpet backing latexes, particularly SBR latex backing, to provide a carpet backing from which stains do not wick back after cleaning. The present invention provides such a carpet backing that provides a reduction in the reappearance of stains after cleaning.

### SUMMARY OF THE INVENTION

The present invention comprises a carpet backing for use on a carpet comprising a styrene-butadiene rubber latex and at least one adsorbent, said backing reducing wicking back of stains after cleaning of the carpet.

The present invention further comprises a method of reducing wicking back of stains in a carpet after cleaning comprising addition of an adsorbent to a carpet backing, and attaching said backing to said carpet.

The present invention further comprises a carpet having an attached carpet backing wherein said backing comprises a styrene-butadiene rubber latex and at least one adsorbent which reduces wicking back of stains after cleaning of the carpet.

The present invention further comprises a process for removing stains from a carpet and reducing wick back of said stains comprising

a) applying to said carpet a carpet backing comprising a styrene-butadiene rubber latex containing at least one adsorbent,

b) contacting said carpet, after staining, with a liquid cleaning agent, and

c) drying said carpet.

### DETAILED DESCRIPTION

Trademarks herein are shown in upper case.

“Wicking back” and “wick back” are defined as the reappearance of a stain on carpet fibers after the carpet has been cleaned and allowed to dry. The present invention comprises a styrene-butadiene rubber (SBR) latex carpet backing containing at least one adsorbent material that reduces the reappearance of stains from spills (wicking back) from the latex after the carpet pile has been cleaned. The SBR latexes of the present invention are particularly effective in reducing the wicking back of stains from the complex mixture of chemicals found in spills of coffee and other water-soluble naturally occurring coloring materials. Such stains typically include those based upon natural plants and vegetables. Examples include tea, wine, fruit juices, herbal and other plant compositions, and mixtures thereof. The SBR latexes containing an adsorbent additive are useful in the latex backing for carpets made with natural fibers such as wool, cotton, jute, sisal, sea grass, coir, and blends thereof; synthetic fibers such as polyamides, polyesters, polyolefins, acrylics, and blends thereof; or blends of natural and synthetic fibers. The present invention further comprises the carpets backed with SBR latexes containing the adsorbent additives of the present invention, a method for reducing wicking back of stains, and cleaning processes used to remove stain and reduce wick back.

The adsorbent materials useful in the practice of the present invention, herein termed the “adsorbent” or “adsorbent additives”, comprise at least one water insoluble adsorbent material. Examples of useful adsorbent additives are silica, alumina, clay, charcoal, carbon, molecular sieves, zeolites, reverse phase silica gel, or size exclusion chromatography media, cellulosic materials, and mixtures thereof. Suitable reverse phase silica gel includes silica surface-bonded to long chain (C₁₈-C₂₄) hydrocarbon chains to give a hydrophobic material. Suitable size exclusion chromatography media include porous particles for separating molecules of different sizes such as dextran polymer or polyacrylamide. Charcoal and clay are preferred.

While not wishing to be bound by theory, it is believed that at least a portion of the stain adsorbs or adheres onto the adsorbent additive, where the stain is “trapped” and its ability to wick back is thus significantly reduced.

Any SBR latex material suitable for carpet backing is suitable for use herein. Commercial SBR latexes suitable as carpet backing comprise a SBR polymer, water, and other additives. A mixture of the SBR polymer and water is first prepared, and then additives such as calcium carbonate, ammonium lauryl sulfate (surfactant), sodium polyacrylate, and other ingredients are added to give a composition suitable for a carpet backing. The composition becomes increasingly viscous as the additives are mixed in, and thorough mixing is necessary. A typical commercial SBR latex, prior to the addition of the adsorbent additives but ready for conventional application as carpet backing, would usually contain by weight, based on the total weight of the latex and additives, water (18-21%), SBR polymer (10-12%), calcium carbonate (68-70%), surfactant such as ammonium lauryl sulfate (0.12-0.2%), sodium polyacrylate (0.07-0.09%) and other ingredients (0.07-0.09%). Finally and for ease of manufacture, air is mixed into the latex with vigorous mixing to form a less viscous foamed latex.

The SBR latex backings of the present invention are prepared at any stage of the latex manufacture, distribution, or at the point of application of the latex backing. Typically, the additives are added immediately prior to foaming of the latex. The adsorbent additives are added to the SBR latexes with the conventional additives or subsequently to pre-formulated latexes prior to applying the latex to the carpet. Again, thorough mixing is necessary for uniform distribution of the additives throughout the latex. The adsorbent additives are added in an amount by weight of from about 0.0075% to about 15%, preferably from about 0.015% to about 7.5%, and most preferably from about 0.04% to about 4.3%.

The invention further comprises a carpet with an attached backing comprising a SBR latex containing at least one said adsorbent additive for the purpose of reducing wick back after cleaning.

The SBR latex backings of the present invention, containing the adsorbent additives, are applied to the carpet by conventional processes. Typically, the process is to foam the latex by vigorous agitation, apply the foamed latex to the back of the carpet, work the latex into the back of the carpets, and heat the carpet and latex to remove water and other volatile latex components to coalesce the latex. Carpets suitable for use herein include those of natural or synthetic fibers, or blends thereof as described above.

The SBR latex backing of the present invention containing the adsorbent additives is ideally utilized in conjunction with stain repellent treatments of the carpet fibers to provide a combination of desirable properties in the carpet. Such properties include blocking, cleaning, trapping stains on carpeting, stain protection, and stain removal. Simple carpet care is provided for residential, commercial, or automotive carpeting, particularly for the otherwise difficult removal of coffee stains and water-soluble naturally occurring coloring materials. Such stains originate in products based on natural plants and vegetables, including but not limited to tea, wine, fruit juices, herbal and other plant compositions, and mixtures thereof. The carpet backing is applied to the carpet by conventional means as noted above.

The invention further comprises a method of reducing wicking back of stains in a carpet after cleaning comprising the addition of at least one adsorbent additive to SBR latex used as the carpet backing. After cleaning, wicking back is significantly reduced due to the adsorbent additive in the carpet backing. The adsorbent additives are those defined above.

The adsorbent additive is present in the backing at from about 0.0075% to about 15% by weight of the latex, and comprises the materials as discussed above. The carpet is comprised of natural fibers or synthetic fibers as described above. Wicking back of stains after cleaning is reduced significantly when compared to carpets without such adsorbent additives in the backing.

Any conventional cleaning process employing a liquid agent is suitable for use in the present invention. Examples are detailed below. Wick back of the stain is reduced due to use of the backing of the present invention containing adsorbent additives.

The present invention further comprises a process for removing stains from a carpet and reducing wick back of said stains comprising
a) applying to said carpet a carpet backing comprising a styrene-butadiene rubber latex containing at least one adsorbent additive,
b) contacting said carpet with a liquid cleaning agent,
c) drying said carpet.

The carpet backing and its application to the carpet are as described above. The carpets are cleaned by any known method. These include, but are not limited to, the following:
1) Deep cleaning with wet or dry extraction.
2) Cleaning with absorbent pad or bonnet, which is a machine with spinning pad attached, with or without a cleaning solution.
3) “Dry” extraction procedures wherein an aqueous pretreatment is applied, a polymer compound is brushed manually or mechanically onto the carpet to absorb the soil, and soil and compound are vacuumed for complete removal.
4) “Dry” foam extraction using a detergent that is foamed, applied, and worked into carpet mechanically, and then wet vacuumed.
5) Hot water extraction or steam cleaning wherein the carpet is pre-conditioned to suspend soil and a cleaning solution is injected into the pile and immediately extracted (American Association of Textile Chemists and Colorists [AATCC] Method 171-1989).
6) Rotary shampoo which is similar to the absorbent pad or bonnet method, except cleaning solution is first injected into the carpet pile.
7) Combinations of the above methods.

The cleaning agents employed are primarily aqueous, but may also contain a co-solvent such as an alcohol or glycol.

The SBR latex compositions containing the adsorbent additives and the method and process of the present invention are useful for reducing wick back of stains in the carpet fibers after cleaning. The SBR latex of the present invention containing the adsorbent additives is valuable to latex manufacturers, latex compounders, and carpet mills as well as consumers.

### Materials and Test Methods

The following materials and test methods were used in the Examples.

Carpet Materials: Four types of carpets were used in the Examples, all of which are available from Invista Inc., Wilmington Del. Two residential samples were residential level loop 2615 denier, 1/10 gauge (0.1 inch or 2.5 mm tuft separation), 30-34 oz/yd² (1.02-1.15 kg/m²), dyed pale yellow, both treated and untreated with a stain resist composition (see below). Two commercial samples were commercial level loop 1245 denier, 1/10 gauge, 26 oz/yd² (0.88 kg/m²), dyed pale yellow, both treated and untreated with a stain resist composition (see below).

The stain resist was a water soluble anionic stain resist available from E. I. du Pont de Nemours and Company, Wilmington Del., prepared according to U.S. Pat. No. 5,460,887, referred to herein as the “stain resist”. Application of the stain resist to the carpet was as described in Test Method 4.

SBR Latex D90-2 was obtained from Southeastern Latex Company, Dalton Ga.

All adsorbent additives used were obtained from Aldrich Chemical, Milwaukee Wis.

Test Method 1

Carpet samples, 6.76×6.76 inch (17.2×17.2 cm) squares of dyed carpet, were cut and placed pile side up on a non-absorbent surface. The pile was cleaned of any unattached materials by vacuuming.

ORIGINAL MAXWELL HOUSE ground coffee (33.8+/−0.05 g), available from Maxwell House Coffee Co., Tarrytown N.Y. was placed into a standard 10-cup coffee filter. Deionized water (1266.2+/−0.05 g) was added and the coffee brewed according to the manufacturers' directions. The pH of the coffee was adjusted to 5.0±0.05 using aqueous solutions containing either 30% aqueous sodium hydrogen sulfate or 10% sodium hydroxide as needed. The coffee was poured into a suitable volumetric dispenser, capable of dispensing 50+/−1 mL portions and the dispenser placed in the hot water bath at 62° C. The coffee was allowed to come to a temperature 140° F.+/−5° F. (60°+/−2.8° C.) and remain at that temperatures for 30+/−5 minutes prior to staining.

A ring, in the shape of an open-ended cylinder or inverted frustum was used, having a diameter of the smaller opening of 2.75 inches (7 cm). Such a ring is described for a different purpose in AATCC Test Method 175-1993. The ring was placed at the center of the carpet sample, with the smaller diameter opening against the pile. The coffee dispenser was set to measure 50+/−1 mL, and purged once prior to staining. With the ring pressed down into the pile, 50 mL of coffee was transferred into a container and immediately poured into the ring and onto the carpet. The coffee was worked into the carpet evenly and thoroughly with the base of the cup. The coffee was allowed to stain the carpet for 4 hours+/−20 minutes.

Test Method 2

Hot water extraction cleaning of carpet samples was performed according to the American Association of Textile Chemists and Colorists (AATCC) Test Method #171 “Cleaning of Carpets: Hot Water (Steam) Extraction Method”, except that no detergent was used.

Test Method 3

A Minolta Chroma Meter CR-210 colorimeter (Minolta Corporation, Ramsey N.J.) was used to grade the stained carpet samples, compared against a control (unstained) carpet to measure the color difference (“Delta E” value). Any unattached materials were removed from the pile prior to grading. Details for measuring the Delta E are provided in the AATCC test method #153 “Color Measurements for Textiles: Instrumental”. The test was repeated as necessary for different carpet colors, constructions, and styles.

The Delta E value measures the difference in color between two samples and is more sensitive than the human eye. The average person can distinguish between the colors of two objects with a Delta E measurement of 1.0 or more. Most of the examples of this invention show a Delta E of greater than 1.0, but a few of the samples show a Delta E of less than 1.0. While the latter examples do not appear visually different, the reduced Delta E still represents an improvement in stain wick back, indicating a reduced residual amount of stain (organic) chemicals in the pile. Thus Delta E values of less than 1.0 still provide benefits in terms of less re-soiling and less bacteria growth.

Delta E values are first made within the 3.5 cm radius area that was stained in comparison with an area away from the stain. Delta E values “around the stain (halo)” are made at a distance of 5 to 10 cm from the center of the stained area and provide a measure of wick back.

A Delta E value of zero represents no color difference between two samples. A larger Delta E value indicates a larger color difference between two samples.

Test Method 4

Dyed carpet was given a flex-nip application of 250% by weight of a bath containing 16 g/L of the stain resist (see above, under Materials) at pH 2.0 (adjusted with sodium bisulfate). The carpet was then heated to 210°-212° F. (99°-100° C.) in an atmospheric cloud (saturated) steamer for 2.5 min. The carpet was rinsed with water, and vacuum extracted to 50% wet pickup. The carpet was dried to a carpet face temperature of 230° F. (110° C.) in a gas-fired oven.

### EXAMPLES

### Example 1

SBR LATEX D90-2 with the amounts of adsorbent additives as specified in Table 1 was added to a plastic mixing bowl and mixed manually until the adsorbent additives were thoroughly incorporated into the SBR latex. The adsorbent additive/latex mixture was put on the backside of a carpet to cover the back surface and then spread evenly with a spatula over the entire back surface. The carpet samples were then dried at room temperature for 1-2 days, latex side up, before staining.

The carpet sample was prepared and stained with coffee according to Test Method 1, then subjected to hot water extraction cleaning according to Test Method 2. Stains were measured according to Test Method 3. Since carpet samples have slight variability, control examples were made for each carpet type and latex additive and also tested. The examples and controls were compared to the corresponding unstained carpet for each carpet type. Results are shown in Table 1.

Delta E represents the difference in color between the stained, cleaned, and dried carpet versus unstained carpet for each control and example. Thus a smaller Delta E for the example compared to the corresponding control represents a smaller color difference and a desirable decrease in the wicking back of the stain.

### Examples 2-27

Carpet backing of SBR LATEX D90-2 was prepared as in Example 1, but using the adsorbent additives and amounts shown in Table 1. Carpet samples were prepared, stained, cleaned and tested as in Example 1. Results are shown in Table 1.

Control Samples A-I

SBR LATEX D90-2 without any adsorbent additives was applied to carpet as in Example 1. Carpet samples were prepared and tested as in Example 1. The controls were tested for each series of Examples as shown in Table 1. For instance, Control B is the control for the same carpet used in Examples 2 and 3, Control I for the same carpet used in Examples 22-27.

TABLE 1

| | Carpet | Additive(s) in Latex | Delta E*** |
|---|---|---|---|
| Example # | Type* | Backing (% w/w)** | (within stain area) |
| Control A | 1 | None | 9.3 |
| Example 1 | 1 | Charcoal 0.4% | 7.9 |
| Control B | 2 | None | 5.6 |
| Example 2 | 2 | Charcoal 0.4% | 5.5 |
| Example 3 | 2 | Silica 2.4% | 4.6 |
| Control C | 3 | None | 8.1 |
| Example 4 | 3 | Clay 4.3% | 6.1 |
| Example 5 | 3 | Charcoal 4.1% | 6.3 |
| Control D | 1 | None | 9.9 |
| Example 6 | 1 | Clay 4.3% | 9.3 |
| Example 7 | 1 | Charcoal 4.1% | 8.5 |
| Control E | 4 | None | 4.3 |
| Example 8 | 4 | Charcoal 4.1% | 3.3 |
| Control F | 2 | None | 7.1 |
| Example 9 | 2 | Clay 4.3% | 5.0 |
| Example 10 | 2 | Charcoal 4.1% | 6.9 |
| Control G | 3 | None | 11.3 |
| Example 11 | 3 | Clay 1.3% | 10.7 |
| Example 12 | 3 | Clay 2.7% | 10.1 |
| Example 13 | 3 | Charcoal 1.3% | 9.7 |
| Example 14 | 3 | Charcoal 2.7% | 10.2 |
| Example 15 | 3 | Charcoal 4.0% | 10.2 |
| Example 16 | 3 | Clay 2.0% and charcoal 2.0% | 10.1 |
| Example 17 | 3 | Clay 2.7% and charcoal 1.3% | 9.7 |

| | Carpet | Additive(s) in Latex | Delta E around |
|---|---|---|---|
| Example # | Type | Backing (% w/w) | stain (halo) |
| Control H | 3 | None | 9.0 |
| Example 18 | 3 | Silica 4.0% | 7.3 |
| Example 19 | 3 | Charcoal 4.0% | 5.6 |
| Example 20 | 3 | Clay 4.0% | 8.2 |
| Example 21 | 3 | Clay 2.7% and charcoal 1.3% | 7.7 |
| Control I | 4 | None | 12.5 |
| Example 22 | 4 | Charcoal 0.06% | 7.0 |
| Example 23 | 4 | Charcoal 0.045% | 10.3 |
| Example 24 | 4 | Charcoal 0.03% | 9.7 |
| Example 25 | 4 | Charcoal 0.015% | 7.7 |
| Example 26 | 4 | Powdered molecular sieves | 10.8 |
| | | 0.038% | |
| Example 27 | 4 | Clay 7.5% | 9.1 |

*Carpet Types:
1. Residential level loop (LL) 2615 denier, 1/10 gauge (0.1 inch or (2.5 mm) tuft separation), 30-34 oz/yd² (1.02-1.15 kg/m²), dyed pale yellow.
2. Commercial level loop 1245 denier, 1/10 gauge, 26 oz/yd² (0.88 kg/m²), dyed pale yellow.
3. As Type 1, but treated with stain resist (Test Method 4).
4. As Type 2, but treated with stain resist (Test Method 4).
**% w/w is the weight of the additive as a percent of the weight of the latex.
***Delta E measured according to Test Method 3. Delta E around stain (halo) indicates the degree of staining for the “wick back” portion of the stain.

Table 1 shows reduced Delta E values for the example versus the control for each example thus indicating decreased wicking back when the carpet backing of the present invention was employed.

What is claimed is:

1. A carpet backing for use on a carpet comprising a styrene-butadiene rubber latex and at least one adsorbent, said backing reducing wicking back of stains after cleaning of the carpet.

2. The carpet backing of claim 1 wherein the adsorbent is silica, alumina, clay, charcoal, carbon, molecular sieve, zeolite, reverse phase silica gel, size exclusion chromatography media, cellulosic material, or mixtures thereof.

3. The carpet backing of claim 2 wherein the adsorbent is clay, charcoal, or mixtures thereof.

4. The carpet backing of claim 1 wherein the adsorbent is present at from about 0.0075% to about 15% by weight of the latex.

5. The carpet backing of claim 1 further comprising calcium carbonate, surfactant, and sodium polyacrylate.

6. The carpet backing of claim 1 for use on a carpet wherein said carpet has fibers which have been treated with at least one protective composition which is a stain resist agent, soil resist agent, oil repellency agent, or water repellency agent.

7. The carpet backing of claim 1 wherein the stain is a product based on natural plants or vegetables.

8. The carpet backing of claim 1 wherein the stain is coffee, tea, fruit juice, vegetable juice, herbal composition, or plant composition.

9. A method of reducing wicking back of stains in a carpet after cleaning comprising addition of an adsorbent to a carpet backing, and attaching said backing to said carpet.

10. The method of claim 9 wherein the adsorbent is silica, alumina, clay, charcoal, carbon, molecular sieve, zeolite, reverse phase silica gel, size exclusion chromatography media, cellulosic material, or mixtures thereof.

11. The method of claim 9 wherein the adsorbent is present at from about 0.0075% to about 15% by weight of the latex.

12. The method of claim 9 wherein the stain is coffee, tea, fruit juice, vegetable juice, herbal composition, plant composition, or mixtures thereof.

13. A carpet having an attached carpet backing wherein said backing comprises a styrene-butadiene rubber latex and at least one adsorbent which reduces wicking back of stains after cleaning of the carpet.

14. The carpet of claim 13 wherein the adsorbent is silica, alumina, clay, charcoal, carbon, molecular sieve, zeolite, reverse phase silica gel, size exclusion chromatography media, cellulosic material, or mixtures thereof.

15. The carpet of claim 13 wherein the adsorbent is present at from about 0.0075% to about 15% by weight of the latex.

16. The carpet of claim 13 wherein the stain is coffee, tea, fruit juice, vegetable juice, herbal composition, plant composition, or mixtures thereof.

17. The carpet of claim 13 which is made of synthetic or natural fibers.

18. The carpet of claim 17 wherein the fibers are polyamide, polyester, polyolefin, wool, acrylic, nylon, cotton, jute, sisal, sea grass, coir, or blends thereof.

19. A process for removing stains from a carpet and reducing wick back of said stains comprising
a) applying to said carpet a carpet backing comprising a styrene-butadiene rubber latex containing at least one adsorbent,
b) contacting said carpet, after staining, with a liquid cleaning agent, and
c) drying said carpet.

20. The process of claim 19 wherein the adsorbent is silica, alumina, clay, charcoal, carbon, molecular sieve, zeolite, reverse phase silica gel, or size exclusion chromatography media, cellulosic material, or mixtures thereof.

21. The process of claim 19 wherein the adsorbent is present at from about 0.0075% to about 15% by weight of the latex.

22. The process of claim 19 wherein the carpet comprises fibers of polyamide, polyester, polyolefin, wool, acrylic, nylon, cotton, jute, sisal, sea grass, coir, or blends thereof.

23. The process of claim 19 wherein the stain comprises coffee, tea, fruit juice, vegetable juice, herbal composition, plant composition, or mixtures thereof.

24. The process of claim 19 wherein the cleaning is by wet extraction, absorbent pad or bonnet, dry extraction, foaming, steaming, shampooing, or combinations thereof.

25. The process of claim 19 wherein the drying is by means of air-drying at ambient temperature.
